(19) United States
(12) Patent Application Publication
(10) Pub. No.: US 2025/0105445 A1
(43) Pub. Date: Mar. 27, 2025

(54) PRELITHIATED THERMALLY STABLE SEPARATOR

(71) Applicant: GM GLOBAL TECHNOLOGY OPERATIONS LLC, Detroit, MI (US)

(72) Inventors: Xingcheng Xiao, Troy, MI (US); Mei Cai, Bloomfield Hills, MI (US)

(21) Appl. No.: 18/471,346

(22) Filed: Sep. 21, 2023

(51) Int. Cl. H01M 50/446; H01M 10/0525; H01M 50/403; H01M 50/434

(52) U.S. Cl. CPC H01M 50/446; H01M 10/0525; H01M 50/403; H01M 50/434

(57) ABSTRACT

A prelithiated separator for use in an electrochemical cell. The prelithiated separator includes a base film including a polymer having a melting point greater than 180° C.; a ceramic directly contacting the base film; and lithium on an outer surface of the prelithiated separator.

### INTRODUCTION

The present disclosure relates to batteries and methods of forming the same. More particularly, the present disclosure relates to prelithiated separators having improved electrochemical and mechanical properties, and methods of making the same.

A battery is a device that converts chemical energy into electrical energy by means of electrochemical reduction-oxidation (redox) reactions. In secondary or rechargeable batteries, these electrochemical reactions are reversible, which allows the batteries to undergo multiple charge and discharge cycles.

Secondary lithium batteries may include one or more electrochemical cells that operate by reversibly passing lithium ions between a negative electrode and a positive electrode. The negative and positive electrodes may be disposed on opposite sides of a porous polymeric separator, and each of the negative and positive electrodes is typically carried on, or connected to, a metallic current collector. The negative and positive electrodes and the polymeric separator are infiltrated with an ionically conductive electrolyte that provides a medium for the conduction of lithium ions through the electrochemical cell between the negative and positive electrodes. An electrochemical potential may be established between the negative and positive electrodes of the electrochemical cell by connecting their respective current collectors to one another via an interruptible external circuit. During discharge, the electrochemical potential established between the negative and positive electrodes drives spontaneous redox reactions within the electrochemical cell and the release of lithium ions and electrons at the negative electrode. The released lithium ions travel from the negative electrode to the positive electrode through the ionically conductive electrolyte, and the electrons travel from the negative electrode to the positive electrode via the external circuit, which generates an electric current. After the negative electrode has been partially or fully depleted of lithium, the electrochemical cell may be recharged by connecting the negative and positive electrodes to an external power source, which drives nonspontaneous redox reactions within the electrochemical cell and the release of the lithium ions and the electrons from the positive electrode.

During initial charging of a secondary lithium battery, an electrically insulating and ionically conductive layer referred to as a solid electrolyte interphase (SEI) may inherently form in-situ on a surface of the negative electrode at an interface between the negative electrode and the electrolyte. This native SEI is believed to inherently form due to the low reduction potential of the electrochemically active material of the negative electrode, which promotes reduction of the electrolyte at the surface of the negative electrode. The SEI forms an ionically conductive (allows transport of Li⁺ ions) and electrically insulating barrier between the negative electrode and the electrolyte. The formation of a stable SEI on the negative electrode may help prevent further physical contact and undesirable side reactions from occurring between the negative electrode material and the electrolyte during operation of the battery.

Chemical reactions between the negative electrode material and the electrolyte that occur during formation of the SEI are parasitic and may consume active lithium, which may lead to irreversible capacity loss and reduced cycle life of the battery. Accordingly, it is desirable to provide separators that enable a rechargeable lithium-ion battery containing the same to exhibit improved first cycle efficiency, energy density, and cycle life.

### SUMMARY

In one exemplary embodiment, the present disclosure provides a prelithiated separator for use in an electrochemical cell. The prelithiated separator may include a base film including a polymer having a melting point greater than 180° C.; a ceramic directly contacting the polymer; and lithium on an outer surface of the prelithiated separator.

In addition to one or more of the features described herein, the polymer having the melting point greater than 180° C. may include a polyaramid, a polyimide, polyethylene terephthalate, polytetrafluoroethylene, a polyimide nanofiber nonwoven, a nano-sized Al₂O₃ and poly(lithium 4-styrenesulfonate)-coated polyethylene membrane, a SiO₂-coated polyethylene, a co-polyimide-coated polyethylene, a polyetherimide, bisphenol-acetone diphthalic anhydride, para-phenylenediamine, expanded polytetrafluoroethylene reinforced polyvinylidenefluoride-hexafluoropropylene, or a combination thereof.

In another exemplary embodiment, the ceramic may include Al₂O₃, SiO₂, ZrO₂, TiO₂, lithium titanate, lithiated zeolite, zeolite, MgO, boehmite, or a combination thereof.

In yet another exemplary embodiment, a thickness of the lithium may compensate for capacity loss during a first cycle of an electrochemical cell comprising the prelithiated separator.

In yet another exemplary embodiment, the lithium may be on one surface of the base film.

In yet another exemplary embodiment, the ceramic directly contacting the polymer may include a mixture of the ceramic and the polymer.

In yet another exemplary embodiment, the ceramic directly contacting the polymer may include a ceramic layer directly on the base film; and the lithium on the outer surface of the prelithiated separator may include lithium directly on the ceramic layer.

In yet another exemplary embodiment, the ceramic layer directly on the base film may include a first ceramic layer directly on a first surface of the base film, and a second ceramic layer directly on a second surface of the base film, the second surface of the base film being opposite the first surface of the base film; and the lithium directly on the ceramic layer may include a first lithium layer directed on the first ceramic layer, and a second lithium layer directly on the second ceramic layer.

In yet another exemplary embodiment, the ceramic layer may be exposed at an edge of the base film.

In one exemplary embodiment, the present disclosure provides a method of forming a prelithiated separator. The method may include depositing a ceramic directly on a base film including a polymer having a melting point greater than 180° C.; and depositing lithium directly on the ceramic to form the prelithiated separator.

In addition to one or more of the features described herein, depositing the lithium may include thermal evaporation, sputtering, ion beam deposition, or a combination thereof.

In another exemplary embodiment, depositing the lithium may include a processing temperature less than the melting point of the polymer.

In yet another exemplary embodiment, the polymer having the melting point greater than 180° C. may include a polyaramid, a polyimide, polyethylene terephthalate, polytetrafluoroethylene, a polyimide nanofiber nonwoven, a nano-sized Al₂O₃ and poly(lithium 4-styrenesulfonate)-coated polyethylene membrane, a SiO₂-coated polyethylene, a co-polyimide-coated polyethylene, a polyetherimide (PEI), bisphenol-acetone diphthalic anhydride (BPADA), para-phenylenediamine, expanded polytetrafluoroethylene reinforced polyvinylidenefluoride-hexafluoropropylene, or a combination thereof.

In yet another exemplary embodiment, the ceramic may include Al₂O₃, SiO₂, ZrO₂, TiO₂, lithium titanate, lithiated zeolite, zeolite, MgO, boehmite, or a combination thereof.

In yet another exemplary embodiment, depositing the lithium directly on the ceramic may include depositing the lithium to a calculated thickness to compensate for capacity loss during a first cycle of an electrochemical cell comprising the prelithiated separator.

In yet another exemplary embodiment, depositing the lithium directly on the ceramic may include depositing the lithium on one surface of the base film.

In yet another exemplary embodiment, depositing the ceramic directly on a base film may include depositing a first ceramic layer directly on a first surface of the base film, and depositing a second ceramic layer directly on a second surface of the base film, the second surface of the base film being opposite the first surface of the base film; and depositing lithium directly on the ceramic may include depositing a first lithium layer directly on the first ceramic layer, and depositing a second lithium layer directly on the second ceramic layer.

In yet another exemplary embodiment, depositing the lithium directly on the ceramic may include retaining an exposed area of the ceramic layer at an edge of the base film.

In one exemplary embodiment, the present disclosure provides a method of forming a prelithiated separator. The method may include forming a base film including a polymer having a melting point greater than 180° C. and a ceramic; and depositing lithium directly on an outer surface of the base film to form the prelithiated separator.

In addition to one or more of the features described herein, the polymer having the melting point greater than 180° C. may include a polyaramid, a polyimide, polyethylene terephthalate, polytetrafluoroethylene, a polyimide nanofiber nonwoven, a nano-sized Al₂O₃ and poly(lithium 4-styrenesulfonate)-coated polyethylene membrane, a SiO₂-coated polyethylene, a co-polyimide-coated polyethylene, a polyetherimide, bisphenol-acetone diphthalic anhydride, para-phenylenediamine, expanded polytetrafluoroethylene reinforced polyvinylidenefluoride-hexafluoropropylene, or a combination thereof; and the ceramic may include Al₂O₃, SiO₂, ZrO₂, TiO₂, lithium titanate, lithiated zeolite, zeolite, MgO thereof.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 schematically shows a disassembled isometric view of a prismatic battery cell that includes an anode, an electrolytic material, a separator, and a cathode, in accordance with the disclosure;

FIG. 2 includes photographs of the separators of Comparative Example 1 and Example 1;

FIG. 3 is a graphical illustration demonstrating open circuit voltage of a cell including the separator of Comparative Example 2 (also referred to herein as “Comparative Example 2 cell”) and a cell including the separator of Example 1 following prelithiation (also referred to herein as “Example 1 cell”);

FIG. 4 is a graphical illustration demonstrating first cycle efficiency and voltage profile of the Comparative Example 2 cell and the Example 1 cell;

FIG. 5 is a graphical illustration demonstrating cycle performance of the Comparative Example 2 cell and the Example 1 cell;

FIG. 6A is a graphical illustration demonstrating cycle performance of the Comparative Example 2 cell and the Example 1 cell; and

FIG. 6B is a graphical illustration demonstrating cycle performance of the Comparative Example 2 cell and the Example 1 cell.

### DETAILED DESCRIPTION

The following description is merely exemplary in nature and is not intended to limit the present disclosure, its application or uses. It should be understood that throughout the drawings, corresponding reference numerals indicate like or corresponding parts and features.

A secondary lithium battery may include a battery case and an electrochemical cell enclosed within the battery case. The battery case may include a metal, such as aluminum or steel, or the battery case may include a film pouch material with multiple laminated layers of metal, plastic, or a combination thereof. The electrochemical cell may include a stack of positive and negative electrodes electrically isolated from one another by porous separators. The positive and negative electrodes and the porous separators of the electrochemical cell may be infiltrated with an ionically conductive electrolyte, for example, by filling the battery case with the electrolyte.

Batteries may be incorporated into energy storage devices, like rechargeable lithium-ion batteries, which may be used in automotive transportation applications (e.g., motorcycles, boats, tractors, buses, mobile homes, campers, and tanks). The present technology, however, may also be used in other electrochemical devices, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. The present disclosure provides a prelithiated separator that enables a rechargeable lithium-ion battery containing the same to exhibit improved first cycle efficiency (e.g., mitigate an initial irreversible capacity loss occurring during a first cycle), energy density, and cycle life.

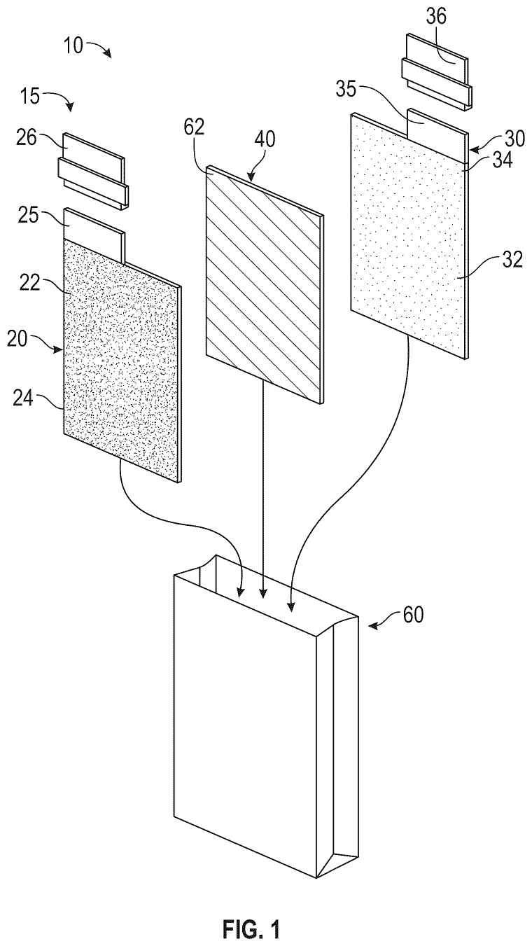

Referring to the drawings, wherein like reference numerals correspond to like or similar components throughout the several Figures, FIG. 1 schematically illustrates an embodiment of a prismatically-shaped lithium ion battery cell 10 that includes an electrode pair 15 having a cathode 20, a separator 40, and an anode 30 that are arranged in a stack and sealed in a flexible pouch 60 containing an electrolytic material 62. In an embodiment of the battery cell, a reference electrode may be arranged between the anode and the cathode. A first, positive battery cell tab 26 and a second, negative battery cell tab 36 protrude from the flexible pouch 60. The terms “anode” and “negative electrode” are used interchangeably. The terms “cathode” and “positive electrode” are used interchangeably. A single electrode pair 15 including an arrangement of the cathode 20, separator 40, and anode 30 is illustrated. It is appreciated that multiple electrode pairs 15 may be arranged and electrically connected in the flexible pouch 60, depending upon the application of the battery cell 10.

The cathode 20 includes a first electroactive material 22 that is arranged on a cathode current collector 24, and the cathode current collector 24 may have a foil portion 25 that extends from the first electroactive material 22 to form the second battery cell tab 26.

The anode 30 includes a second electroactive material 32 that is arranged on an anode current collector 34. The anode current collector 34 may be a metallic substrate with a foil portion 35 that extends from the second electroactive material 32 to form the first battery cell tab 36.

The cathode and anode current collectors 24, 34 may be metallic plate shaped elements that contact respective first and second electroactive materials 22, 32 over an appreciable interfacial surface area. The purpose of the cathode and anode current collectors 24, 34 is to exchange free electrons with respective first and second electroactive materials 22, 32 during discharging and charging.

In certain battery cell chemistries, such as those utilizing nanostructured silicon, including silicon nanoparticles, silicon nanowires, porous Si, or a combination thereof, initial cycle efficiency may be low, for example, due to formation of a significant amount of SEI on the high surface area of the anodes, and there may be a notable irreversible capacity loss. Offsetting capacity loss may maintain a desired energy density.

In the case of other anode materials, such as SiOₓ-based anodes, the first cycle efficiency also may be low due to the structural conditions that result in the formation of nanosized silicon domains embedded in lithium silicate. The lithium silicate is a non-active material for Li, meaning the lithium silicate may not host additional Li or release Li during the charging and discharging process. The Li consumed in forming lithium silicate may not be reversible, and there may be irreversible capacity loss. To address capacity loss, prelithiation may compensate for Li loss in the system.

As used herein, the term “prelithiated” (e.g., prelithiated separator) means that the separator is lithiated during formation of the separator and prior to assembly of a battery and initial battery cycling. The surplus of lithium in the prelithiated separator may compensate for the loss of active lithium in the electrochemical cell(s) of the battery, which may occur during initial cycling or repeated cycling of the battery, for example, due to various lithium-consuming parasitic chemical reactions within the electrochemical cell(s) of the battery. The disclosed prelithiated separator may help increase the reversible capacity and cycle life of secondary lithium batteries.

The prelithiated separator provides electrical separation (e.g., preventing physical contact) between the negative electrode and the positive electrode. The prelithiated separator also provides a minimal resistance path for internal passage of lithium ions. The prelithiated separator may include a base film including a polymer having a melting point greater than 180° C.; a ceramic directly contacting the polymer; and lithium on an outer surface of the prelithiated separator.

The prelithiated separator may include, for example, a microporous polymeric separator. The polymer has a melting point greater than 180° C. The polymer may include, for example, a polyaramid, a polyimide, polyethylene terephthalate, polytetrafluoroethylene, a polyimide nanofiber nonwoven, a nano-sized Al₂O₃ and poly(lithium 4-styrenesulfonate)-coated polyethylene membrane, a SiO₂-coated polyethylene, a co-polyimide-coated polyethylene, a polyetherimide (PEI), bisphenol-acetone diphthalic anhydride (BPADA), para-phenylenediamine, expanded polytetrafluoroethylene reinforced polyvinylidenefluoride-hexafluoropropylene, or a combination thereof. Thermal deformation of the prelithiated separator during formation may be reduced or avoided by using a thermally stable polymer (e.g., having a melting point greater than 180° C.) as a base film thereof.

The prelithiated separator further includes a ceramic directly contacting the polymer. The ceramic may include Al₂O₃, SiO₂, ZrO₂, TiO₂, lithium titanate, lithiated zeolite, zeolite, MgO, boehmite, or a combination thereof. The ceramic may act as a preventive measure against potential short circuits.

The base film may include a mixture of the ceramic and the polymer. The base film may include the ceramic (e.g., ceramic filler), for example, in the form of particles, embedded in a polymer matrix. The ceramic may be present in an amount of, for example, 5 weight percent (wt. %) to 70 wt. %, based on a total weight of the ceramic and polymer. The ceramic (e.g., filler or particles) may be uniformly distributed in the polymer matrix. Ceramic filler may be mixed with precursors for forming the base film to form a polymer separator base film including ceramic filler.

The prelithiated separator may include a ceramic layer directly on the polymer (e.g., the ceramic layer may be between the polymer base film and the lithium). The ceramic layer may be disposed on one or more sides of the base film. Ceramic may be deposited on one surface of the base film or two opposite surfaces of the base film. The ceramic coating may be made by casting process, in which ceramic powder may be mixed with polymer binder and solvent to make slurry, which is cast on a polymer separator base film. In the coating process, first, binder may be dissolved into a solvent, then ceramic powder may be added into the solution to make a slurry. The slurry may be cast on both sides of a polymer separator base film. The thickness of the cast slurry may be 0.5 micrometer (μm) to 10 μm or 2 μm to 3 μm.

Lithium is present on an outer surface of the prelithiated separator. Lithium may be deposited on (e.g., directly on) the ceramic layer, when present, or the base film including the ceramic, when present. Lithium may be deposited, for example, by thermal evaporation, sputtering, ion beam deposition, or a combination thereof. Lithium may be deposited on one surface of the separator or two opposite surfaces of the separator, for example, when ceramic is deposited on two opposite surfaces of the base film.

A thickness of the lithium may compensate for capacity loss during a first cycle of an electrochemical cell including the prelithiated separator. For example, 5 μm thick lithium with an area of 1 square centimeter (cm²) may be equivalent to 1 milliampere-hours per square centimeter (mAh/cm²) capacity. If an anode loading (original design capacity) is 5 mAh/cm² and the first cycle efficiency is 80%, the lithium loss is 20%×5 mAh/cm²=1 mAh/cm². Deposition of at least 5 μm thick lithium should fully compensate the lithium loss.

The ceramic layer may be exposed at an edge of the base film or the base film including ceramic (e.g., ceramic filler) may be exposed at an edge of the base film. Controlled surface coverage of the lithium to retain a portion of the ceramic layer exposed at an edge of the base film or the base film including ceramic filler exposed at an edge of the base film may avoid short circuit at a polarity tab (disclosed further herein) after assembly of an electrochemical cell by preventing lithium from directly contacting another electrode tab after the prelithiated separator has been folded or deformed.

During assembly of an electrochemical cell including the prelithiated separator, the prelithiated separator may be laminated or wrapped onto a surface of the negative electrode. The lamination process could be achieved by pressing the prelithiated separator to (e.g., against) the anode through (e.g., using) a roller of a rolling machine. The lithium surface of the prelithiated separator may face either the positive electrode or the negative electrode in an assembled electrochemical cell.

A method of forming the prelithiated separator includes depositing a ceramic layer directly on a base film including a polymer having a melting point greater than 180° C.; and depositing lithium directly on the ceramic to form the prelithiated separator. Deposition of the lithium may include a processing temperature less than the melting point of the polymer.

A method of forming the prelithiated separator may include fabricating (e.g., forming) a base film (e.g., a composite base film) including a polymer having a melting point greater than 180° C. and a ceramic (e.g., in which ceramic particles as a filler are present in a polymer having a melting point greater than 180° C.); and depositing lithium directly on the base film to form the prelithiated separator. Deposition of the lithium may include a processing temperature less than the melting point of the polymer.

The battery can generate an electric current during discharge by way of reversible electrochemical reactions that occur when the external circuit is closed (to connect the negative electrode and the positive electrode) and when the negative electrode has a lower potential than the positive electrode. The chemical potential difference between the negative electrode and the positive electrode drives electrons produced by a reaction, for example, the oxidation of intercalated lithium, at the negative electrode, through the external circuit towards the positive electrode. Lithium ions, which are also produced at the negative electrode, are concurrently transferred through the electrolyte towards the positive electrode. The electrons flow through the external circuit and the lithium ions migrate across the electrolyte to the positive electrode, where they may be plated, reacted, or intercalated. The electric current passing through the external circuit can be harnessed and directed through the load device (in the direction of the arrows) until the lithium in the negative electrode is depleted and the capacity of the battery is diminished.

The battery can be charged or reenergized at any time by connecting an external power source (e.g., charging device) to the battery to reverse the electrochemical reactions that occur during battery discharge. The external power source that may be used to charge the battery may vary depending on the size, construction, and particular end-use of the battery. Exemplary external power sources include, for example, an alternating current (AC)-direct current (DC) converter connected to an AC electrical power grid though a wall outlet and a motor vehicle alternator. The connection of the external power source to the battery promotes a reaction, for example, non-spontaneous oxidation of intercalated lithium, at the positive electrode so that electrons and lithium ions are produced. The electrons, which flow back towards the negative electrode through the external circuit, and the lithium ions, which move across the electrolyte back towards the negative electrode, reunite at the negative electrode and replenish it with lithium for consumption during the next battery discharge cycle. A complete discharging event followed by a complete charging event is considered to be a cycle, where lithium ions are cycled between the positive electrode and the negative electrode.

The negative electrodes may be “double-sided,” meaning that each of the negative electrodes includes discrete first and second layers of electrochemically active negative electrode material disposed on opposite sides of a negative electrode current collector. Each of the negative electrodes may also include a lithium metal layer, which may be disposed between the first and second negative electrode active material layers or on a major facing surface of either the first or the second negative electrode active material layer.

Positive and negative electrodes disposed at the ends of the electrochemical cell may be single-sided, meaning that the electrodes each include a single layer of electrochemically active negative or positive electrode material disposed on one side of a metal current collector. A positive electrode disposed at a first end of the electrochemical cell may include a positive electrode active material layer disposed on a positive electrode current collector, and a negative electrode disposed at an opposite second end of the electrochemical cell may include a negative electrode active material layer disposed on a negative electrode current collector. The negative and positive electrodes disposed between the single-sided positive and negative electrodes may be double-sided, meaning that the electrodes each include two discrete layers of electrochemically active negative or positive electrode material disposed on opposite sides of a metal current collector. A double-sided negative electrode may include a first negative electrode active material layer disposed on a first side of a negative electrode current collector and a second negative electrode active material layer disposed on an opposite second side of the negative electrode current collector. A double-sided positive electrode may include a first positive electrode active material layer disposed on a first side of a positive electrode current collector and a second positive electrode active material layer disposed on an opposite second side of the positive electrode current collector.

A battery may include one double-sided negative electrode and one double-sided positive electrode spaced-apart from a double-sided negative electrode by a separator. The battery may include multiple repeating units of double-sided negative and positive electrodes spaced-apart from one another by separators. The positive and negative electrodes and the separators may be assembled in the form of a stack, for example, using a round winding, prismatic winding, single sheet stacking, Z-folding, or other cell stacking process. The positive electrode current collectors may be electrically coupled to a positive polarity tab and the negative electrode current collectors may be electrically coupled to a negative polarity tab. The positive and negative polarity tabs may extend outside of the battery case and may be coupled to a power source or load via an external circuit.

Prior to hermetically sealing the electrochemical cell within a battery case, the positive and negative electrodes and the separator(s) may be infiltrated with the ionically conductive electrolyte. When infiltrated with the electrolyte, each adjacent pair of positive and negative electrode active material layers may define one electrochemical cell of the battery. A first electrochemical cell may be defined by a positive electrode active material layer disposed on a positive electrode current collector and a first negative electrode active material layer disposed on a first side of a negative electrode current collector. A second electrochemical cell may be defined by a second negative electrode active material layer disposed on a second side of the negative electrode current collector and a first positive electrode active material layer disposed on a first side of the positive electrode current collector, and a third electrochemical cell may be defined by a second positive electrode active material layer disposed on a second side of a positive electrode current collector and a negative electrode active material layer disposed on a negative electrode current collector.

An electrolyte may infiltrate the first and second negative electrode active material layers and establish an ionically conductive pathway for the transport of lithium ions from the lithium metal layer to the first negative electrode active material layer, the second negative electrode active material layer, or a combination thereof prior to initial cycling and operation of the battery. The lithium metal layer may be referred to as being “ionically coupled” to the first negative electrode active material layer, the second negative electrode active material layer, or a combination thereof via the electrolyte.

A double-sided negative electrode may be configured to provide one or both of its associated electrochemical cells with a stoichiometric surplus of lithium prior to initial charging and operation of the battery. The negative electrode may include a lithium metal layer having a first major surface and an opposite second major surface. A double-sided negative electrode may be configured such that, when the negative electrode is infiltrated with the electrolyte, the lithium metal layer is in physical contact with the electrolyte and is ionically coupled to the first negative electrode active material layer, the second negative electrode active material layer, or a combination thereof via the electrolyte. The electrolyte may be in physical contact with first major surface of the lithium metal layer, the second major surface of the lithium metal layer, or a combination thereof. The electrolyte may enable lithium ion transport from the lithium metal into the first negative electrode active material layer, the second negative electrode active material layer, or a combination thereof prior to initial cycling and operation of the battery. The lithium metal layer may be disposed between the first and second negative electrode active material layers, or the lithium metal layer may be disposed on a major facing surface of either the first or the second negative electrode active material layers.

Separators may be interposed between confronting or facing surfaces of adjacent pairs of positive and negative electrode active material layers. For example, in a first electrochemical cell, a confronting or facing surface of the positive electrode active material layer may be is spaced apart from a confronting or facing surface of a negative electrode active material layer by a separator.

When the negative electrode is infiltrated with electrolyte, the electrolyte may infiltrate pores of the porous first and second negative electrode active material layers and comes into direct physical contact with the lithium metal layer(s). When the electrolyte makes physical contact with the lithium metal layer(s), an ionically conductive pathway may be established within the negative electrode that allows for the transport of lithium ions from the lithium metal layer into the first negative electrode active material layer, the second negative electrode active material layer, or a combination thereof. Lithium ions released from the lithium metal layer and intercalated into the negative electrode active material layers may provide the associated electrochemical cells with a stoichiometric surplus of active lithium to take part in the electrochemical reactions occurring within the cells.

After lithium ions are released from the lithium metal layer, the lithium ions may be intercalated into the negative electrode active material layers, dissolved in the electrolyte, intercalated into the positive electrode active material layers, or a combination thereof. Lithium ions released from the lithium metal layer may not return thereto. After initial charging, repeated cycling of the battery, or a combination thereof, lithium ions in the lithium metal layer may be entirely consumed by the electrochemical reactions occurring within the electrochemical cell(s).

A double-sided negative electrode may include a negative electrode current collector in the form of a nonporous metal foil having a first side and an opposite second side thereof. A first lithium metal layer may be formed on the first side of the negative electrode current collector and a second lithium metal layer may be formed on the second side of the negative electrode current collector. The first and second lithium metal layers may be nonporous and may be in the form of nonporous lithium metal foils. A first negative electrode active material layer may be formed on the first side of the negative electrode current collector over the first lithium metal layer, and a second negative electrode active material layer may be formed on the second side of the negative electrode current collector over the second lithium metal layer.

A first current collector may be positioned at or near the negative electrode. The first current collector may be a metal foil, metal grid or screen, or expanded metal including copper or any other appropriate electrically conductive material. A second current collector may be positioned at or near the positive electrode. The second current collector may be a metal foil, metal grid or screen, or expanded metal including aluminum or any other appropriate electrically conductive material. The first current collector and the second current collector may be the same or different. The first current collector and the second electrode current collector respectively collect and move free electrons to and from an external circuit. For example, an interruptible external circuit and a load device may connect the negative electrode (through the first current collector) and the positive electrode (through the second current collector).

Each of the first current collector, the negative electrode, the separator, the positive electrode, and the second current collector may be prepared as relatively thin layers (for example, from several microns to a millimeter or less in thickness) and assembled in layers connected in series arrangement to provide a suitable electrical energy, battery voltage and power package, for example, to yield a Series-Connected Elementary Cell Core (“SECC”). The battery may further include electrodes connected in parallel to provide suitable electrical energy, battery voltage, and power for example, to yield a Parallel-Connected Elementary Cell Core (“PECC”).

The electrolyte may facilitate transport of lithium ions between the adjacent pairs of positive and negative electrode active material layers within the electrochemical cell of the battery. The electrolyte may be a nonaqueous liquid electrolyte solution including a lithium salt dissolved in a nonaqueous aprotie organic solvent or a mixture of nonaqueous aprotie organic solvents.

Examples of lithium salts include lithium hexafluorophosphate (LiPF₆), lithium perchlorate (LiClQ₄), lithium tetrachloroaluminate (LiAlCH), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato) borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane) sulfonylimide (LiN(CF₃SO₂)₂), lithium bis(fluorosulfonyl)imide (LiN(FSO₂)₂) (LiSFI), or a combination thereof.

Examples of nonaqueous aprotic organic solvents include alkyl carbonates, for example, cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate. methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran. 2-methyltetrahydrofuran). 1.3-dioxolane), sulfur compounds (e.g., sulfolane), or a combination thereof.

The electrolyte may include solid-state electrolyte particles, which may have an average particle diameter greater than or equal to about 0.02 μm to less than or equal to about 20 μm, optionally greater than or equal to about 0.1 μm to less than or equal to about 10 μm, and optionally greater than or equal to about 0.1 μm to less than or equal to about 1 μm. The solid-state electrolyte particles may have an average particle diameter greater than or equal to 0.02 μm to less than or equal to 20 μm, optionally greater than or equal to 0.1 μm to less than or equal to 10 μm, and optionally greater than or equal to 0.1 μm to less than or equal to 1 μm. For example, the solid-state electrolyte particles may include sulfide-based particles, halide-based particles, hydride-based particles, or other solid-state electrolyte particles, for example, having low grain-boundary resistance, or a combination thereof.

The sulfide-based particles may include a pseudobinary sulfide system, a pseudoternary sulfide system, a pseudoquaternary sulfide system, or a combination thereof. Example pseudobinary sulfide systems include systems include Li₂S—P₂S₅ systems (such as, Li₃PS₄, Li₇P₃S₁₁, and Li_{9.6}P₃S₁₂), Li₂S—SnS₂ systems (such as, Li₄SnS₄), Li₂S—SiS₂ systems, Li₂S—GeS₂ systems, Li₂S—B₂S₃ systems, Li₂S—Ga₂S₃ system, Li₂S—P₂S₃ systems, and Li₂S—Al₂S₃ systems. Example pseudoternary sulfide systems include Li₂O—Li₂S—P₂S₅ systems, Li₂S—P₂S₅—P₂O₅ systems, Li₂S—P₂S₅—GeS₂ systems (such as, Li_{3.25}Ge_{0.25}P_{0.75}S₄ and Li₁₀GeP₂S₁₂ (LGPS)), Li₂S—P₂S₅—LiX systems (where X is F, Cl, Br, or I) (such as, Li₆PS₅Br, Li₆PS₅Cl, L₇P₂S₈I, and Li₄PS₄I), Li₂S—As₂S₅—SnS₂ systems (such as, Li_{3.833}Sn_{0.833}As_{0.166}S₄), Li₂S—P₂S₅—Al₂S₃ systems, Li₂S—LiX—SiS₂ systems (where X is F, Cl, Br, or I), 0.4 LiI·0.6 Li₄SnS₄, and Li₁₁Si₂PS₁₂. Example pseudoquaternary sulfide systems include Li₂O—Li₂S—P₂S₅—P₂O₅ systems, Li_{9.54}Si_{1.74}P_{1.44}S_{11.7}Cl_{0.3}, Li₇P_{2.9}Mn_{0.1}S_{10.7}I_{0.3}, and Li_{10.35}[Sn_{0.27}Si_{1.08}]P_{1.65}S₁₂.

The halide-based particles may include, for example, Li₃YCl₆, Li₃InCl₆, Li₃YBr₆, LiI, Li₂CdCl₄, Li₂MgCl₄, LiCdI₄, Li₂ZnI₄, Li₃OCl, or a combination thereof; and the hydride-based particles may include, for example, LiBH₄, LiBH₄—LiX (where x=Cl, Br, or I), LiNH₂, Li₂NH, LiBH₄—LiNH₂, Li₃AlH₆, or a combination thereof.

The electrolyte may be a polymeric gel. For example, a cell may include a positive electrode layer, a silicon (e.g., columnar silicon) anode (e.g., negative electrode) layer, the disclosed prelithiated separator, and a current collector for each of the positive electrode layer and the silicon anode layer. The polymeric gel electrolyte may be present all the layers (e.g., the positive electrode layer, the silicon anode layer, and the separating layer).

The polymeric gel electrolyte may be used to wet particle-particle interfaces in an SSB to enhance cell performance. For example, a cell may include a positive electrode layer, solid-state electrolyte particles within the positive electrode layer, a silicon anode layer, the disclosed prelithiated separator between the positive electrode layer and the silicon anode layer, and a current collector for each of the positive electrode layer and the silicon anode layer. The polymeric gel electrolyte may be present all the layers (e.g., the positive electrode layer, the silicon anode layer, and the separating layer). The polymeric gel electrolyte may wet (e.g., fill) 5% to 100%, for example, 80%, of the porosity of the solid electrolyte layer including solid-state electrolyte particles.

The negative electrode may be formed from a lithium host material that is capable of functioning as a negative terminal of a lithium-ion battery. For example, the negative electrode may be defined by a plurality of the negative solid-state electroactive particles. The negative electrode may be a composite including a mixture of the negative solid-state electroactive particles and solid-state electrolyte particles as disclosed herein. The negative electrode may be in the form of a layer having a thickness greater than or equal to about 10 μm to less than or equal to about 5,000 μm, for example, greater than or equal to about 10 μm to less than or equal to about 500 μm and optionally greater than or equal to about 10 μm to less than or equal to about 100 μm, for example, about 20 μm.

The negative electrode may include greater than or equal to about 30 wt. % to less than or equal to about 98 wt. %, and optionally greater than or equal to about 50 wt. % to less than or equal to about 95 wt. %, of the negative solid-state electroactive particles, and greater than or equal to 0 wt. % to less than or equal to about 50 wt. %, and optionally greater than or equal to about 5 wt. % to less than or equal to about 20 wt. %, of solid-state electrolyte particles. The negative electrode may include greater than or equal to 30 wt. % to less than or equal to 98 wt. %, and optionally greater than or equal to 50 wt. % to less than or equal to 95 wt. %, of the negative solid-state electroactive particles, and greater than or equal to 0 wt. % to less than or equal to 50 wt. %, and optionally greater than or equal to 5 wt. % to less than or equal to 20 wt. %, of solid-state electrolyte particles.

The negative solid-state electroactive particles may be lithium-based, for example, a lithium alloy or lithium metal. The negative solid-state electroactive particles may be silicon-based including, for example, a silicon alloy, a silicon-graphite mixture, or a combination thereof. The negative electrode may be a carbonaceous anode and the negative solid-state electroactive particles may include a negative electroactive material, such as graphite, graphene, hard carbon, soft carbon, carbon nanotubes (CNTs), or a combination thereof. The negative electrode may include a negative electroactive material, such as lithium titanium oxide (Li₄Ti₅O₁₂); a metal oxides such as TiO₂, V₂O₅, or a combination thereof; a metal sulfide, such as FeS; or a combination thereof. The negative solid-state electroactive particles may include lithium, graphite, graphene, hard carbon, soft carbon, carbon nanotubes, silicon, a silicon-containing alloy, a tin-containing alloy, other lithium-accepting materials, or a combination thereof.

The negative electrode may further include a conductive additive, a binder material, or a combination thereof. For example, the negative solid-state electroactive particles, the solid-state electrolyte particles, or a combination thereof may be optionally intermingled with an electrically conductive material that provide an electron conduction path, a polymeric binder material that improves the structural integrity of the negative electrode, or a combination thereof.

For example, the negative solid-state electroactive particles, the solid-state electrolyte particles, or a combination thereof may be optionally intermingled with binders, such as sodium carboxymethyl cellulose (CMC), styrene ethylene butylene styrene copolymer (SEBS), styrene butadiene styrene copolymer (SBS), PVDF, PTFE, ethylene propylene diene monomer (EPDM) rubber, nitrile butadiene rubber (NBR), styrene-butadiene rubber (SBR), polyethylene glycol (PEO), a lithium polyacrylate (LiPAA) binder, or a combination thereof. Electrically conductive materials may include, for example, carbon-based materials or a conductive polymer. Carbon-based materials may include, for example, particles of graphite, acetylene black (such as KETCHEN™ black or DENKA™ black), carbon nanofibers and nanotubes, graphene (such as graphene oxide), carbon black (such as Super P), or a combination thereof. Examples of a conductive polymer may include polyaniline, polythiophene, polyacetylene, and polypyrrole. Mixtures of a conductive additive, a binder material, or a combination thereof may be used.

The negative electrode may include greater than or equal to 0 wt. % to less than or equal to about 30 wt. %, and optionally greater than or equal to about 2 wt. % to less than or equal to about 10 wt. %, of the electrically conductive additive; and greater than or equal to 0 wt. % to less than or equal to about 20 wt. %, and optionally greater than or equal to about 1 wt. % to less than or equal to about 10 wt. %, of the binder. The negative electrode may include greater than or equal to 0 wt. % to less than or equal to 30 wt. %, and optionally greater than or equal to 2 wt. % to less than or equal to 10 wt. %, of the electrically conductive additive; and greater than or equal to 0 wt. % to less than or equal to 20 wt. %, and optionally greater than or equal to 1 wt. % to less than or equal to 10 wt. %, of the binder.

The positive electrode may be formed from a lithium-based or electroactive material that can undergo lithium intercalation and deintercalation while functioning as the positive terminal of the battery. For example, the positive electrode may be defined by a plurality of the positive solid-state electroactive particles. The positive electrode may be a composite including a mixture of the positive solid-state electroactive particles and solid-state electrolyte particles as disclosed herein. The positive electrode may be in the form of a layer having a thickness greater than or equal to about 10 μm to less than or equal to about 5,000 μm, for example, greater than or equal to about 10 μm to less than or equal to about 500 μm, and optionally greater than or equal to about 10 μm to less than or equal to about 100 μm, for example, about 40 μm.

The positive electrode may include greater than or equal to about 30 wt. % to less than or equal to about 98 wt. %, and optionally greater than or equal to about 50 wt. % to less than or equal to about 95 wt. %, of the positive solid-state electroactive particles, and greater than or equal to 0 wt. % to less than or equal to about 50 wt. %, and optionally greater than or equal to about 5 wt. % to less than or equal to about 20 wt. %, of solid-state electrolyte particles. The positive electrode may include greater than or equal to 30 wt. % to less than or equal to 98 wt. %, and optionally greater than or equal to 50 wt. % to less than or equal to 95 wt. %, of the positive solid-state electroactive particles, and greater than or equal to 0 wt. % to less than or equal to 50 wt. %, and optionally greater than or equal to 5 wt. % to less than or equal to 20 wt. %, of solid-state electrolyte particles.

The positive electrode may be a layered-oxide cathode, a spinel cathode, or a polyanion cathode. For example, the cathode may be a layered-oxide cathode (e.g., rock salt layered oxides), and the positive solid-state electroactive particles may include a positive electroactive material of LiCoO₂, LiNiₓMn_{y}Co_{1-x-y}O₂ (where 0≤x≤1 and 0≤y≤1), LiNiₓMn_{y}Al_{1-x-y}O₂ (where 0<x≤1 and 0≤y≤1), LiNiₓMn₁₋ₓO₂ (where 0≤x≤1), Li^{1+x}MO₂ (where 0≤x≤1), or a combination thereof for solid-state lithium-ion batteries. The spinel cathode may include a positive electroactive material, such as LiMn₂O₄ and LiNi_{0.5}Mn_{1.5}O₄. The polyanion cation may include, for example, a phosphate, such as LiFePO₄, LiVPO₄, LiV₂(PO₄)₃, Li₂FePO₄F, Li₃Fe₃ (PO₄)₄, or Li₃V₂ (PO₄) F₃ for lithium-ion batteries, a silicate, such as LiFeSiO₄, or a combination thereof for lithium-ion batteries. The positive solid-state electroactive particles may include a positive electroactive material of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂ (PO₄)₃, Li₂FePO₄F, Li₃Fe₃ (PO₄)₄, Li₃V₂ (PO₄) F₃, LiFeSiO₄, or a combination thereof. The positive solid-state electroactive particles may be coated (for example, by LiNbO₃, Al₂O₃, or a combination thereof), the positive electroactive material may be doped (for example, by aluminum, magnesium, or a combination thereof), or a combination thereof. The positive electroactive material may include nickel-manganese-cobalt 811 (NMC811); nickel-manganese-cobalt 622 (NMC622); lithium cobalt oxide (LiCoO₂); lithium iron phosphate (LiFePO₄); high-energy nickel-manganese-cobalt-oxide (HENMC) (e.g., over-lithiated layered oxide cathode or lithium-rich NMC); lithium-manganese-nickel-oxide (LMNO); or a combination thereof.

The positive electrode may further include a conductive additive, a binder material, or a combination thereof. For example, the positive solid-state electroactive particles, the solid-state electrolyte particles, or a combination thereof may be optionally intermingled with an electrically conductive material that provides an electron conduction path, a polymeric binder material that improves the structural integrity of the positive electrode, or a combination thereof.

For example, the positive solid-state electroactive particles, the solid-state electrolyte particles, or a combination thereof, may be optionally intermingled with binders, such as sodium CMC, SEBS, SBS, PVDF, PTFE, EPDM rubber, NBR, SBR, PEO, a LiPAA binder, or a combination thereof. Electrically conductive materials may include, for example, carbon-based materials or a conductive polymer. Carbon-based materials may include, for example, particles of graphite, acetylene black (such as KETCHEN™ black or DENKA™ black), carbon nanofibers and nanotubes, graphene (such as graphene oxide), carbon black (such as Super P), or a combination thereof. Examples of a conductive polymer may include polyaniline, polythiophene, polyacetylene, and polypyrrole. Mixtures of a conductive additive, a binder material, or a combination thereof may be used.

The positive electrode may include greater than or equal to 0 wt. % to less than or equal to about 30 wt. %, and optionally greater than or equal to about 2 wt. % to less than or equal to about 10 wt. %, of the electrically conductive additive; and greater than or equal to 0 wt. % to less than or equal to about 20 wt. %, and optionally greater than or equal to about 1 wt. % to less than or equal to about 10 wt. %, of the binder. The positive electrode may include greater than or equal to 0 wt. % to less than or equal to 30 wt. %, and optionally greater than or equal to 2 wt. % to less than or equal to 10 wt. %, of the electrically conductive additive; and greater than or equal to 0 wt. % to less than or equal to 20 wt. %, and optionally greater than or equal to 1 wt. % to less than or equal to 10 wt. %, of the binder.

The positive electrode current collectors and the positive polarity tab may be formed from aluminum (Al) or another appropriate electrically conductive material. The negative electrode current collectors and the negative polarity tab may be made of copper, nickel, an alloy thereof, stainless steel, or other appropriate electrically conductive material. The positive and negative electrode current collectors may be porous or nonporous. For example, the positive and negative electrode current collectors may be in the form of nonporous metal foils, perforated metal foils, porous metal meshes, or a combination thereof.

The lithium metal layer may include a layer of lithium (Li) metal or a lithium metal alloy. The negative electrode material layer may consist essentially of lithium metal and may include greater than 97 wt. % lithium or, more preferably, greater than 99 wt. % lithium. The lithium metal layer may be porous or nonporous. For example, the lithium metal layer may be in the form of a nonporous metal foil, a perforated (porous) metal foil, or a porous metal mesh. The lithium metal layer may have a thickness in a range of 20 micrometers (μm) to 40 μm.

The first current collector may be a first bipolar current collector, the second current collector may be a second bipolar current collector, or a combination thereof. For example, the first bipolar current collector, the second bipolar current collector, or a combination thereof may be a cladded foil, for example, where one side (e.g., the first side or the second side) of the current collector includes one metal (e.g., first metal) and another side (e.g., the other side of the first side or the second side) of the current collector includes another metal (e.g., second metal). The cladded foil may include, for example, aluminum-copper (Al—Cu), nickel-copper (Ni—Cu), stainless steel-copper (SS—Cu), aluminum-nickel (Al—Ni), aluminum-stainless steel (Al—SS), and nickel-stainless steel (Ni—SS). The first bipolar current collector, the second bipolar current collector, or a combination thereof may be pre-coated, such as graphene or carbon-coated aluminum current collectors.

The size and shape of the battery may vary depending on the particular applications for which it is designed. Battery-powered vehicles and hand-held consumer electronic devices are two examples where the battery would most likely be designed to different size, capacity, voltage, energy, and power-output specifications. The battery may also be connected in series or parallel with other similar lithium-ion cells or batteries to produce a greater voltage output, energy, and power if it is required by the load device. The battery can generate an electric current to the load device that can be operatively connected to the external circuit. The load device may be fully or partially powered by the electric current passing through the external circuit when the battery is discharging. While the load device may be any suitable electrically-powered device, a few specific examples of power-consuming load devices include an electric motor for a hybrid vehicle or an all-electric vehicle, a laptop computer, a tablet computer, a cellular phone, and cordless power tools or appliances, by way of non-limiting example. The load device may also be an electricity-generating apparatus that charges the battery for purposes of storing electrical energy.

Certain features of the current technology are further illustrated in the following non-limiting examples.

### EXAMPLES

### Comparative Example 1

The separator of Comparative Example 1 included an Al₂O₃-coated polyethylene separator having a melting point of 130° C. The coating thickness was about 3 micrometers (μm) and a thickness of the base film was about 9 μm.

### Example 1

The separator of Example 1 included a lithiated zeolite-coated polyaramid separator. The coating thickness was about 3 μm and a thickness of the base film was about 9 μm.

### Lithium Thermal Evaporation

About 10 grams of lithium ingots were placed inside a tantalum crucible, which was then securely mounted and connected between two electrical poles. Positioned directly above the crucible was the separator of Comparative Example 1 or Example 1, attached to a copper foil-covered Mo plate, all within the confines of a vacuum chamber. Prior to the deposition process, the chamber underwent a thorough evacuation to reach a pressure of 10-7 Torr. Subsequently, an electric current was applied to the crucible, effectively heating the lithium inside. Precise control over the heating power was maintained at 20%. Throughout the deposition procedure, the thickness of the deposited lithium was accurately monitored using a quartz crystal microbalance. The final thickness of the lithium coating was about 2 μm.

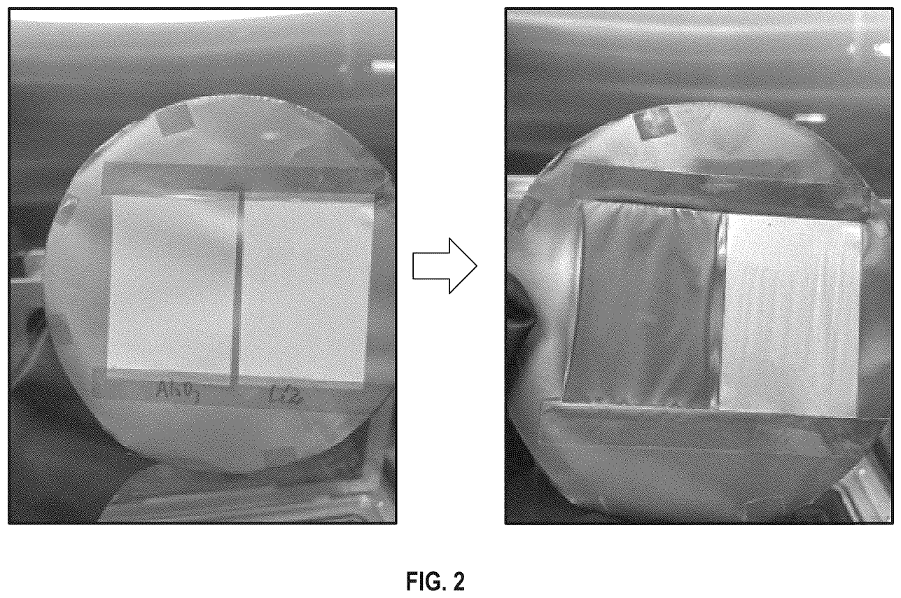

FIG. 2 includes photographs of the separators of Comparative Example 1 (labelled “Al₂O₃”, referring to the Al₂O₃-coated polyethylene separator) and Example 1 (labelled “LiZ” (lithiated zeolite, referring to the lithiated zeolite-coated separator) before lithium thermal evaporation (left hand picture) and after lithium thermal evaporation (right hand picture). The ceramic-coated polyaramid separator of Example 1 was minimally deformed during the lithium thermal evaporation process, while the Al₂O₃-coated separator largely deformed during the lithium thermal evaporation process.

### Comparative Example 2

The separator of Comparative Example 2 included a lithiated zeolite-coated polyaramid separator similar to that included in the separator of Example 1 prior to prelithiation. The separator of Comparative Exampled 2 was not prelithiated, as was the separator of Example 1.

### Cell Performance

Coin cells (2032) were formed with the separator of Comparative Example 2 or the separator of Example 1 following prelithiation, a positive electroactive material of nickel-manganese-cobalt 622 (NMC622), a negative electroactive material of micrometer sized-Si, and electrolyte of 1 mole per liter (molar (M)) lithium hexafluorophosphate (LiPF₆) in ethylmethylcarbonate (EMC))/fluoroethylene carbonate (FEC)) in a weight ratio of 1:4, NMC622 loading of 3.75 milliampere-hours per square centimeter (mAh/cm²), a negative-to-positive (N/P) ratio of 2. The diameter of the anode was 14 millimeters (mm) and the diameter of cathode was 13.5 mm.

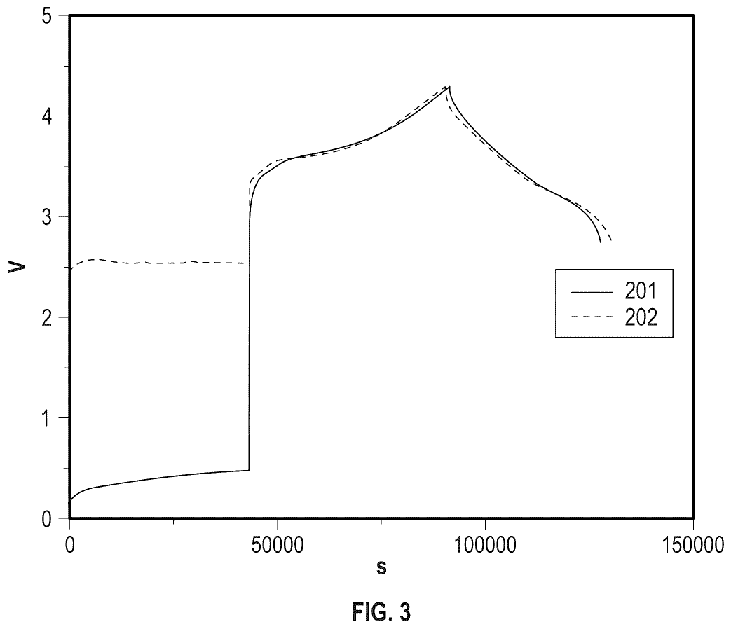

FIG. 3 is a graphical illustration demonstrating first cycle efficiency of the cell including the separator of Comparative Example 2 (also referred to herein as “Comparative Example 2 cell”) and the cell including the separator of Example 1 following prelithiation (also referred to herein as “Example 1 cell”), in which the x-axis represents test time (seconds(s)), the y-axis represents voltage (volts (V)), plot 201 is the Comparative Example 2 cell, and plot 202 is the Example 1 cell. The Open Circuit Voltage (OCV) of the Example 1 cell after assembly is 2.5 V compared to 0.25 V for the Comparative Example 2 cell, indicating the presence of metallic Li on the separator. A slightly lower first cycle charge capacity indicates that silicon has been prelithiated during the OCV holding period.

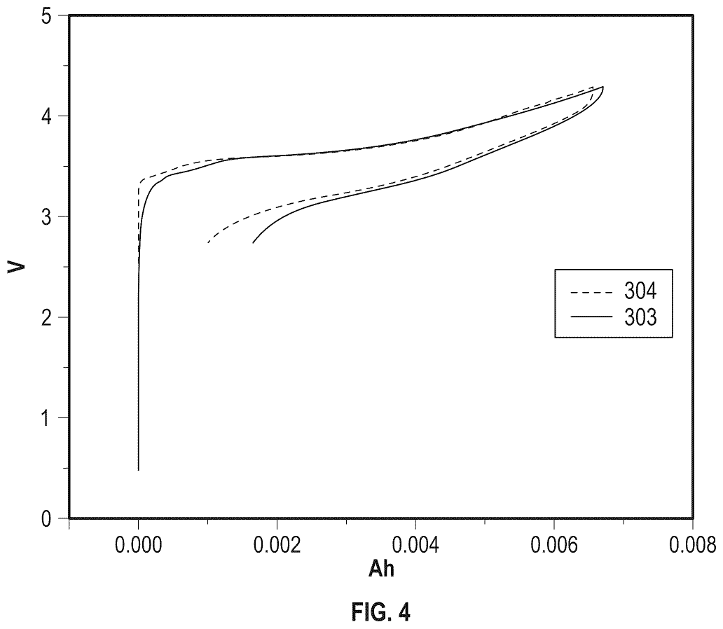

FIG. 4 is a graphical illustration demonstrating first cycle efficiency of the Comparative Example 2 cell and the Example 1 cell, in which the x-axis represents capacity (ampere-hours (Ah)), the y-axis represents voltage (V), plot 303 is the Comparative Example 2 cell, and plot 304 is the Example 1 cell. FIG. 4 indicates a higher state of charge for the Example 1 cell as compared to the Comparative Example 2 cell.

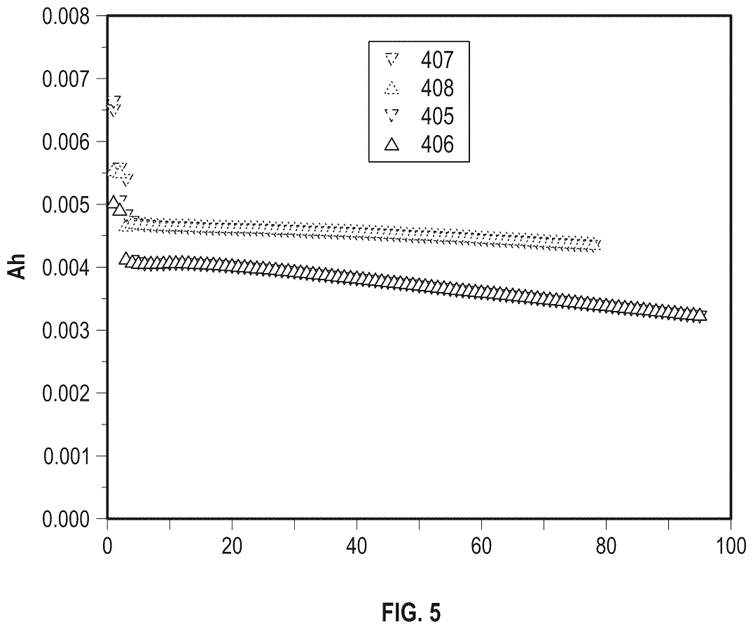

FIG. 5 is a graphical illustration demonstrating cycle performance of the Comparative Example 2 cell and the Example 1 cell, in which the x-axis represents cycle number and the y-axis represents capacity (Ah), plot 405 is the charge capacity of the Comparative Example 2 cell, plot 406 is the discharge capacity of the Comparative Example 2 cell, plot 407 is the charge capacity of the Example 1 cell, and plot 408 is the discharge capacity of the Example 1 cell. A higher discharge capacity for the Example 1 cell indicates that the capacity loss caused by solid electrolyte interphase (SEI) formation has been compensated. As a result of Li compensation for the irreversible capacity loss during the first cycle, the battery exhibits an increased charge-discharge capacity during normal operation.

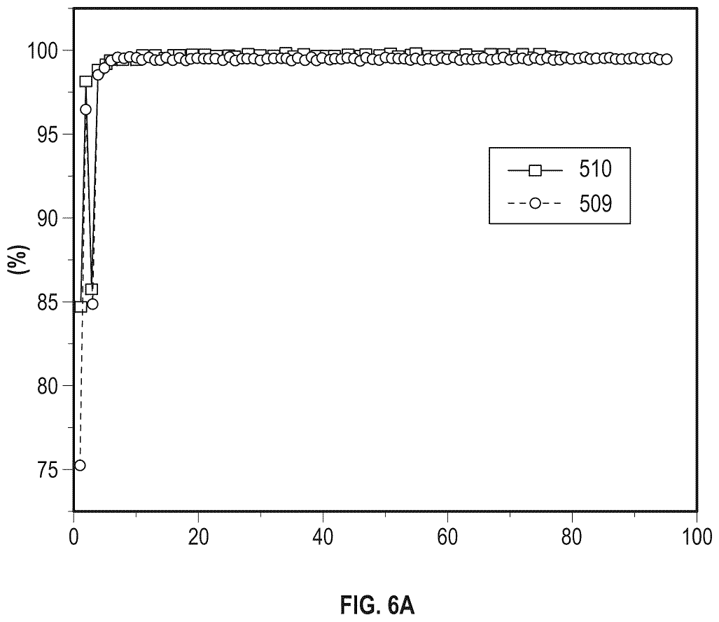

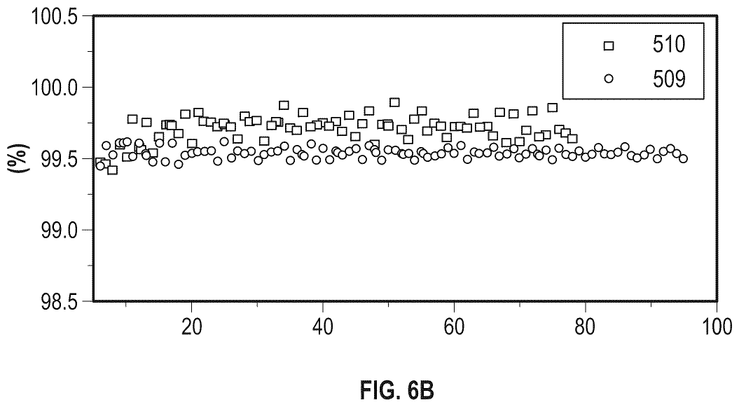

FIG. 6A and FIG. 6B are graphical illustrations demonstrating cycle performance of the Comparative Example 2 cell and the Example 1 cell, in which the x-axis represents cycle number, the y-axis represents cycle efficiency (CE) (percent (%)), plot 509 is the Comparative Example 2 cell, and plot 510 is the Example 1 cell. The first cycle efficiency of the Example 1 cell was 85% and the first cycle efficiency of the Comparative Example 2 cell was 75%. The cycle efficiency can be further improved by applying a Li coating.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or base film is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A prelithiated separator for use in an electrochemical cell, the prelithiated separator comprising:
a base film comprising a polymer having a melting point greater than 180° C.;
a ceramic directly contacting the polymer; and
lithium on an outer surface of the prelithiated separator.

2. The prelithiated separator of claim 1, wherein the polymer having the melting point greater than 180° C. comprises a polyaramid, a polyimide, polyethylene terephthalate, polytetrafluoroethylene, a polyimide nanofiber nonwoven, a nano-sized Al₂O₃ and poly(lithium 4-styrenesulfonate)-coated polyethylene membrane, a SiO₂-coated polyethylene, a co-polyimide-coated polyethylene, a polyetherimide, bisphenol-acetone diphthalic anhydride, para-phenylenediamine, expanded polytetrafluoroethylene reinforced polyvinylidenefluoride-hexafluoropropylene, or a combination thereof.

3. The prelithiated separator of claim 1, wherein the ceramic comprises Al₂O₃, SiO₂, ZrO₂, TiO₂, lithium titanate, lithiated zeolite, zeolite, MgO, boehmite, or a combination thereof.

4. The prelithiated separator of claim 1, wherein a thickness of the lithium compensates for capacity loss during a first cycle of an electrochemical cell comprising the prelithiated separator.

5. The prelithiated separator of claim 1, wherein the lithium is on one surface of the base film.

6. The prelithiated separator of claim 1, wherein the ceramic directly contacting the polymer comprises a mixture of the ceramic and the polymer.

7. The prelithiated separator of claim 1, wherein:
the ceramic directly contacting the polymer comprises a ceramic layer directly on the base film; and
the lithium on the outer surface of the prelithiated separator comprises lithium directly on the ceramic layer.

8. The prelithiated separator of claim 7, wherein:
the ceramic layer directly on the base film comprises
a first ceramic layer directly on a first surface of the base film, and
a second ceramic layer directly on a second surface of the base film, the second surface of the base film being opposite the first surface of the base film; and
the lithium directly on the ceramic layer comprises
a first lithium layer directly on the first ceramic layer, and
a second lithium layer directly on the second ceramic layer.

9. The prelithiated separator of claim 7, wherein the ceramic layer is exposed at an edge of the base film.

10. A method of forming a prelithiated separator, the method comprising:
depositing a ceramic directly on a base film comprising a polymer having a melting point greater than 180° C.; and
depositing lithium directly on the ceramic to form the prelithiated separator.

11. The method of claim 10, wherein depositing the lithium comprises thermal evaporation, sputtering, ion beam deposition, or a combination thereof.

12. The method of claim 10, wherein depositing the lithium comprises a processing temperature less than the melting point of the polymer.

13. The method of claim 10, wherein the polymer having the melting point greater than 180° C. comprises a polyaramid, a polyimide, polyethylene terephthalate, polytetrafluoroethylene, a polyimide nanofiber nonwoven, a nano-sized Al₂O₃ and poly(lithium 4-styrenesulfonate)-coated polyethylene membrane, a SiO₂-coated polyethylene, a co-polyimide-coated polyethylene, a polyetherimide, bisphenol-acetone diphthalic anhydride, para-phenylenediamine, expanded polytetrafluoroethylene reinforced polyvinylidenefluoride-hexafluoropropylene, or a combination thereof.

14. The method of claim 10, wherein the ceramic comprises Al₂O₃, SiO₂, ZrO₂, TiO₂, lithium titanate, lithiated zeolite, zeolite, MgO thereof.

15. The method of claim 10, wherein depositing the lithium directly on the ceramic comprises depositing the lithium to a calculated thickness to compensate for capacity loss during a first cycle of an electrochemical cell comprising the prelithiated separator.

16. The method of claim 10, wherein depositing the lithium directly on the ceramic comprises depositing the lithium on one surface of the base film.

17. The method of claim 10, wherein:
depositing the ceramic directly on a base film comprises
depositing a first ceramic layer directly on a first surface of the base film, and
depositing a second ceramic layer directly on a second surface of the base film, the second surface of the base film being opposite the first surface of the base film; and
depositing lithium directly on the ceramic comprises
depositing a first lithium layer directly on the first ceramic layer, and
depositing a second lithium layer directly on the second ceramic layer.

18. The method of claim 10, wherein depositing the lithium directly on the ceramic comprises retaining an exposed area of the ceramic at an edge of the base film.

19. A method of forming a prelithiated separator, the method comprising:
forming a base film comprising a polymer having a melting point greater than 180° C. and a ceramic; and
depositing lithium directly on an outer surface of the base film to form the prelithiated separator.

20. The method of claim 19, wherein:
the polymer having the melting point greater than 180° C. comprises a polyaramid, a polyimide, polyethylene terephthalate, polytetrafluoroethylene, a polyimide nanofiber nonwoven, a nano-sized Al₂O₃ and poly(lithium 4-styrenesulfonate)-coated polyethylene membrane, a SiO₂-coated polyethylene, a co-polyimide-coated polyethylene, a polyetherimide, bisphenol-acetone diphthalic anhydride, para-phenylenediamine, expanded polytetrafluoroethylene reinforced polyvinylidenefluoride-hexafluoropropylene, or a combination thereof; and
the ceramic comprises Al₂O₃, SiO₂, ZrO₂, TiO₂, lithium titanate, lithiated zeolite, zeolite, MgO thereof.
